(19) United States
(12) Patent Application Publication
(10) Pub. No.: US 2008/0165892 A1
(43) Pub. Date: Jul. 10, 2008

(54) Using the Preamble in an OFDM-Based Communications System to Indicate the Number of Guard Tones

(76) Inventors: Yunsong Yang, San Diego, CA (US); Jianmin Lu, San Diego, CA (US)

Correspondence Address: SLATER & MATSIL, L.L.P., 17950 PRESTON RD, SUITE 1000, DALLAS, TX, 75252-5793, US

(21) Appl. No.: 11/934,401

(22) Filed: Nov. 2, 2007

Related U.S. Application Data
(60) Provisional application No. 60/884,412, filed on Jan. 10, 2007.

(51) Int. Cl. H04L 27/00

(52) U.S. Cl. 375/299; 375/340

(57) ABSTRACT

Indicating the number of guard tones on the preamble frames is described for an OFDM or ODFMA based wireless communication system. The information of the number of guard tones or the range of the number of guard tones used on certain channels is indicated before the mobile station demodulates those channels. The mobile station uses this information to minimize the loss of modulation symbols when decoding those channels.

This application claims the benefit of U.S. Provisional Application No. 60/884,412, filed on Jan. 10, 2007, entitled “METHOD FOR INDICATING THE NUMBER OF GUARD TONES ON THE PREAMBLE IN AN OFDM BASED COMMUNICATION SYSTEM,” which application is hereby incorporated herein by reference.

### TECHNICAL FIELD

The present invention relates, in general, to a wireless communications system, and more particularly, to using the preamble in an orthogonal frequency division multiple access (OFDMA)-based wireless communication system to indicate the number of guard tones.

### BACKGROUND

In wideband wireless communication systems, the signal often tends to weaken from frequency selective fading due to multi-path transmissions. Frequency selective fading is a radio propagation anomaly generally caused by the partial cancellation of a radio signal by itself. As the signal arrives at the receiver by multiple different paths, and at least one of the paths is changing (lengthening or shortening), the combination of the multiple signals sometimes causes partial signal cancellations.

Orthogonal frequency division multiplexing (OFDM) systems have been proposed to overcome the problem of frequency selective fading by dividing the total bandwidth into multiple subcarriers, such that the bandwidth on each subcarrier is sufficiently narrow to enable the data modulation symbols carried by that subcarrier to experience relatively flat fading. An OFDMA system uses the OFDM modulation technique to multiplex the data traffic of several mobile stations in both frequency and time.

FIG. 1 is a block diagram illustrating a typical example of framing structure 10 in an OFDM or OFDMA-based wireless communications system. Communication stream 100 includes the stream of frames that make up the communication transmission. Communication stream 100 typically has multiple preamble frames, such as preamble frame 101, which delimit a particular number, i.e., M, of traffic frames, such as M traffic frames 102-103. The unit made up of the preamble and traffic frames is known as a superframe, such as superframe 103.

Superframe 103 is made up from preamble frame 101 and traffic frames 102 through 103. In an OFDM system, preamble frame 101 and traffic frame 102 consists of multiple OFDM symbols. For example, traffic frame 103 contains OFDM symbol 1-104, OFDM symbol 2-105, through OFDM symbol N-106. Each OFDM symbol, such as OFDM symbol 105, includes inverse fast Fourier transform (IFFT) symbol 109, which is the result of an IFFT operation on the modulation data sequence, cyclic prefix (CP) 108, which is a copy of the last portion of IFFT symbol 109 and is inserted before the IFFT symbol 109, and two windowing periods 107 and 110, which shape the modulation pulse so that the radio spectrum of the transmitted signal meets the emission mask requirement set forth by the radio regulatory body, such as the Federal Communication Commission (FCC) in the United States.

Preamble 101 of superframe 103 provides control information for a mobile station to acquire the base station signals in the power-up procedure or to continue to receive the signaling of the updated system parameters after the mobile station becomes active in the system.

FIG. 2 is a diagram illustrating an exemplary OFDM preamble structure. Preamble 200 comprises eight OFDM symbols, including, in the order in which each is transmitted: one OFDM symbol for the primary broadcast control channel (PBCCH), PBCCH symbol 201, which includes the information of the number of guard tones used in the system; four OFDM symbols, SBCCH/QPCH symbols 202, which comprise the secondary broadcast control channels (SBCCHs) in the even-numbered superframes and comprise the quick paging channels (QPCHs) in the odd-numbered superframes; one OFDM symbol for the acquisition pilot, TDM1 203, that is used by the mobile station to acquire: (1) the superframe and the OFDM symbol timing, (2) the size of the fast Fourier transform (FFT) used on the superframe preamble, and (3) the length of the CP used in the system; one OFDM symbol for the acquisition pilot, TDM2 204, that carries 9-bit sector identity information, known as PilotPN, in asynchronous systems, or carries 9-bit PilotPhase in synchronous systems; and one OFDM symbol for the acquisition pilot, TDM3 205, that carries additional 9-bit system parameters. The 9-bit PilotPN and PilotPhase information carried by TDM2 204 is generally used to facilitate signal processing gain across different superframe preambles, where the PilotPhase is typically equal to PilotPN+system time, where system time is the superframe index.

FIG. 3 is a flowchart illustrating an existing procedure for a mobile station to acquire the wireless system. After the mobile station powers up, it first acquires the superframe and OFDM symbol timing, the FFT size of the preamble, and the CP length in step 300. The preamble FFT size and CP length are determined by constantly correlating the received signal with a number of hypotheses of the transmitted waveforms. Each such hypothesis typically corresponds to a unique combination of the FFT size and CP length information. When the highest correlation among all hypotheses exceeds a certain threshold, the mobile station will declare the acquisition of the superframe and the OFDM symbol timing, and will then use the FFT size and CP length that correspond to the hypotheses with the highest correlation to decode the rest of the superframe preamble frame.

When the carrier bandwidth of the particular system is 5 MHz or less, the FFT size of the preamble is typically the same size as the traffic frames, which is usually 512. However, in systems where the carrier bandwidth is greater than 5 MHz, the FFT size for the traffic frames may be 2 or more times higher than the preamble FFT size. Therefore, if the FFT size used in the preamble frames is 512, the mobile station will still need to decode the PBCCH in order to extract the exact FFT size used on the traffic frames. In step 301, the mobile station decodes the acquisition pilot, TDM2, to acquire the PilotPhase or PilotPN information, depending on the synchronization of the network.

The mobile station descrambles the acquisition pilot, TDM3, using the detected information contents in TDM2, as the scrambling seed, then, in step 302, decodes the information on TDM3. The information bits included in TDM3 are typically: (1) a 1-bit Sync/Asynch bit to indicate if the system is synchronous or asynchronous; (2) a 1-bit half-duplex bit to indicate if the half-duplex operation is supported; (3) a 1-bit frequency-reuse on preamble bit to indicate if the frequency-reuse is used on the PBCCH and SBCCH; and (4) the four least significant bits (LSBs) of the system time to indicate when the first sub-packet of the PBCCH encoded packet starts in an asynchronous sector.

In step 303, the mobile station decodes the PBCCH, which carries various information, including the exact FFT size used on the traffic frames, the number of guard tones used in the traffic frames, and the nine LSBs of the system time to enable the mobile stations to convert the PilotPhase to PilotPN for a synchronous system. In step 304, the mobile station decodes the SBCCH in the even-numbered superframes, which include enough sector configuration information to enable the mobile station to demodulate the forward link traffic channels. In step 305, the mobile station decodes the additional system configuration parameters that are broadcast in the overhead signaling messages via the traffic channels and enable the mobile station to start the random access procedure on the reverse link.

In a direct spread spectrum communication system, such as code division multiple access (CDMA)-based systems, because the energy is spread over the entire bandwidth, the CDMA channel occupies a certain bandwidth given a certain spreading factor or chip rate. In order to adapt the CDMA system to a variety of channel bandwidths efficiently, the chip rate is typically changed. Considering this operation, one advantage of OFDM or OFDMA-based systems is that two zones of guard tones (or guard sub-carriers) on the two edges of the bandwidth may be set up, such that there is generally no energy transmitted on these guard tones. Therefore, even though the FFT size of an OFDM system is limited to a few choices of 2's power, the effective occupied channel bandwidth may be very flexible by defining the number of guard tones, thereby allowing OFDM-based systems to fit into a wide range of spectrum easily.

Usually, a particular FFT size corresponds to a certain channel bandwidth if half of that FFT size cannot fit into the same channel bandwidth. This means that the number of guard tones can be almost as large as half of the FFT size.

As described previously, the mobile station acquires the exact number of guard tones in the traffic frames and SBCCH from the information contained in the PBCCH. However, the OFDM preamble may also contain a number of guard tones, but not necessarily the same number of guard tones as contained in the traffic frames and SBCCH.

A problem arises when the mobile station tries to demodulate and decode the PBCCH without knowing the number of guard tones that the base station may have applied. Without knowledge of the appropriate number of guard tones, the decoding may have erroneous results. One compromised solution in use provides for the mobile station to use the worst case scenario for determining the number of guard tones when decoding the PBCCH. Using this worst case assumption, when the allowable channel bandwidth is slightly larger than what half of the FFT size can fit into, the mobile station may ignore almost half of the modulation symbols on the PBCCH during decoding. The result of this compromise is the unnecessary loss of decoding performance on the PBCCH, thereby prolonging system acquisition delay.

### SUMMARY OF THE INVENTION

Representative embodiments of the present invention provide methods for acquiring signal in an OFDMA-based network that includes receiving an OFDMA signal stream from a base station, decoding one or more acquisition pilots in a superframe preamble prior to decoding a primary broadcast control channel (PBCCH) symbol, detecting a guard tone code within the decoded one or more acquisition pilots, and decoding the PBCCH symbol using the guard tone code.

Additional representative embodiments of the present invention provide methods that include detecting a number of guard tones used in coding a superframe preamble in an OFDM network, encoding the number of guard tones into one or more acquisition pilots of the superframe preamble, and transmitting the superframe preamble in an OFDM data stream.

Additional representative embodiments of the present invention provide mobile stations that are made up from a processor, memory, a first decoding component stored in the memory, where the processor operates the first decoding component to decode one or more acquisition pilots in a superframe preamble of an OFDMA-based network communication stream, and where the first decoding component directs the mobile station to decode the one or more acquisition pilots prior to decoding a PBCCH symbol of the superframe preamble in an OFDMA-based network. The mobile stations also include a guard tone code table stored in the memory, where the processor accesses the guard tone code table during execution of the first decoding component upon detection of a guard tone code in the decoded one or more acquisition pilots, and a second decoding component in the memory, where the processor operates the second decoding component to decode the PBCCH symbol of the superframe preamble using information in the guard tone code table corresponding to the guard tone code.

Additional representative embodiments of the present invention provide base stations in an OFDMA-based network that include a processor, memory, a coding component operable by the processor to encode a number of guard tones used to code a superframe preamble, where the encoded number of guard tones is placed into one or more acquisition pilots of the superframe preamble, and a transmitter for transmitting a communication stream including at least the superframe preamble to a plurality of mobile stations.

Additional representative embodiments of the present invention provide computer program products having a computer readable medium with computer program logic recorded thereon, including code for receiving an OFDMA signal stream from a base station in an OFDMA-based network, code for decoding one or more acquisition pilots in a superframe preamble prior to decoding a PBCCH symbol, code for detecting a guard tone code within the decoded one or more acquisition pilots, and code for decoding the PBCCH symbol using the guard tone code.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram illustrating a typical example of a framing structure in an OFDM or OFDMA-based wireless communications system;

FIG. 2 is a diagram illustrating an exemplary OFDM preamble structure;

FIG. 3 is a flowchart illustrating an existing procedure for a mobile station to acquire the wireless system;

FIG. 4A is a block diagram illustrating acquisition pilots TDM1, TDM2, and TDM3 in a superframe preamble of an asynchronous OFDMA-based network configured according to one embodiment of the present invention;

FIG. 4B is a block diagram illustrating acquisition pilots TDM1 403, TDM2 404, and TDM3 405 in a superframe preamble of a synchronous OFDMA-based network configured according to one embodiment of the present invention;

FIG. 5A is a block diagram illustrating acquisition pilots TDM1, TDM2, and TDM3 in a superframe preamble of an asynchronous OFDMA-based network configured according to one embodiment of the present invention;

FIG. 5B is a block diagram illustrating acquisition pilots TDM1, TDM2, and TDM3 in a superframe preamble of a synchronous OFDMA-based network configured according to one embodiment of the present invention;

FIG. 6A is a block diagram illustrating acquisition pilots TDM1, TDM2, and TDM3 in a superframe preamble of an OFDMA-based network configured according to one embodiment of the present invention;

FIG. 6B is a block diagram illustrating acquisition pilots TDM1, TDM2, and TDM3 in a superframe preamble of an OFDMA-based network configured according to one embodiment of the present invention;

FIG. 7 is a block diagram illustrating OFDMA-based network configured according to one embodiment of the present invention;

FIG. 8 is a flowchart illustrating example steps executed to implement one embodiment of the present invention;

FIG. 9 is a flowchart illustrating example steps executed to implement one embodiment of the present invention; and

FIG. 10 illustrates a computer system adapted to use embodiments of the present invention

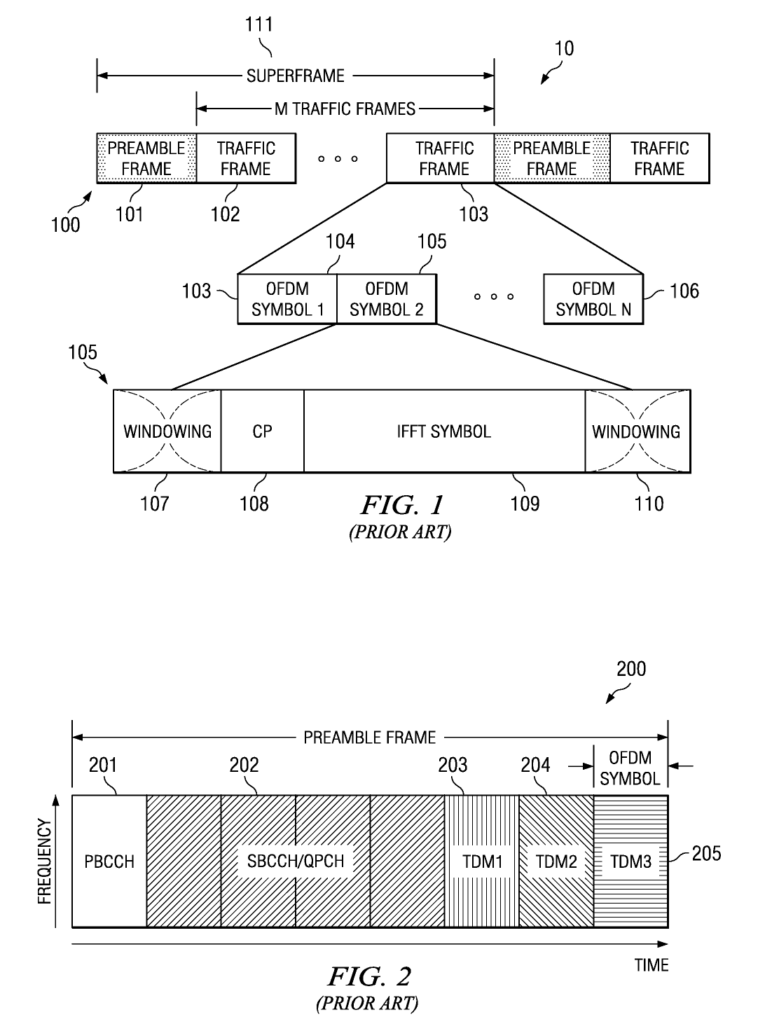

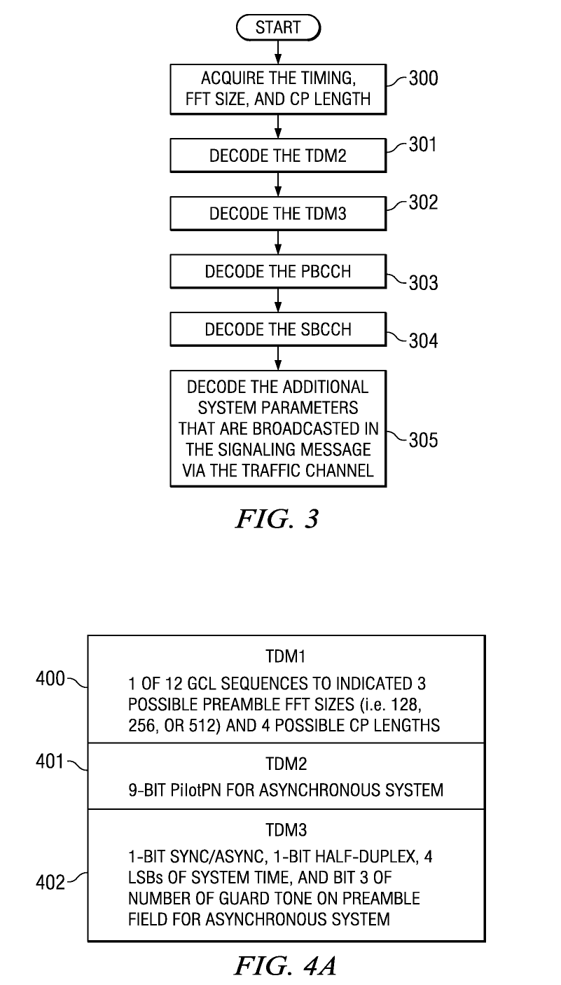

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention provides a unique method and system for indicating the number of guard tones on the preamble in an OFDM or OFDMA based communication system. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

In accordance with one aspect of the present invention, a method for indicating the number of guard tones on the preamble in an OFDM or OFDMA based communication system is disclosed, the method comprising: indicating the number of guard tones that is used on the preamble frames by the base station using at least one acquisition pilot; indicating the number of guard tones that is used on the traffic frames by the base station using the PBCCH; decoding the acquisition pilot(s) by the mobile station before decoding the PBCCH; using the information of the number of guard tones detected from the acquisition pilot(s) to demodulate and to decode the PBCCH; using the information of the number of guard tones detected from the acquisition pilot(s) to demodulate and to decode the SBCCH if the PBCCH is decoded correctly; and using the information of the number of guard tones detected from the PBCCH to demodulate and to decode the traffic frames.

In accordance with another aspect of the present invention, a second method for indicating the range of the number of guard tones on the preamble in an OFDM or OFDMA based communication system is disclosed, the method comprising: dividing all possible choices of the number of guard tones that can be used on the preamble frames into at least two exclusive groups wherein each group has at least one choice of number of guard tones that can be used on the preamble frames; indicating the group index to which the exact number of guard tones that is used on the preamble frames belongs by the base station using at least one acquisition pilot; indicating the number of guard tones that is used on the traffic frames by the base station using the PBCCH; decoding the acquisition pilot(s) by the mobile station before decoding the PBCCH; using the worse case scenario number of guard tones within the group of the group index that is detected from the acquisition pilot(s) to demodulate and to decode the PBCCH and SBCCH; and using the information of the number of guard tones used on the traffic that is detected from the PBCCH to demodulate and to decode the traffic frames.

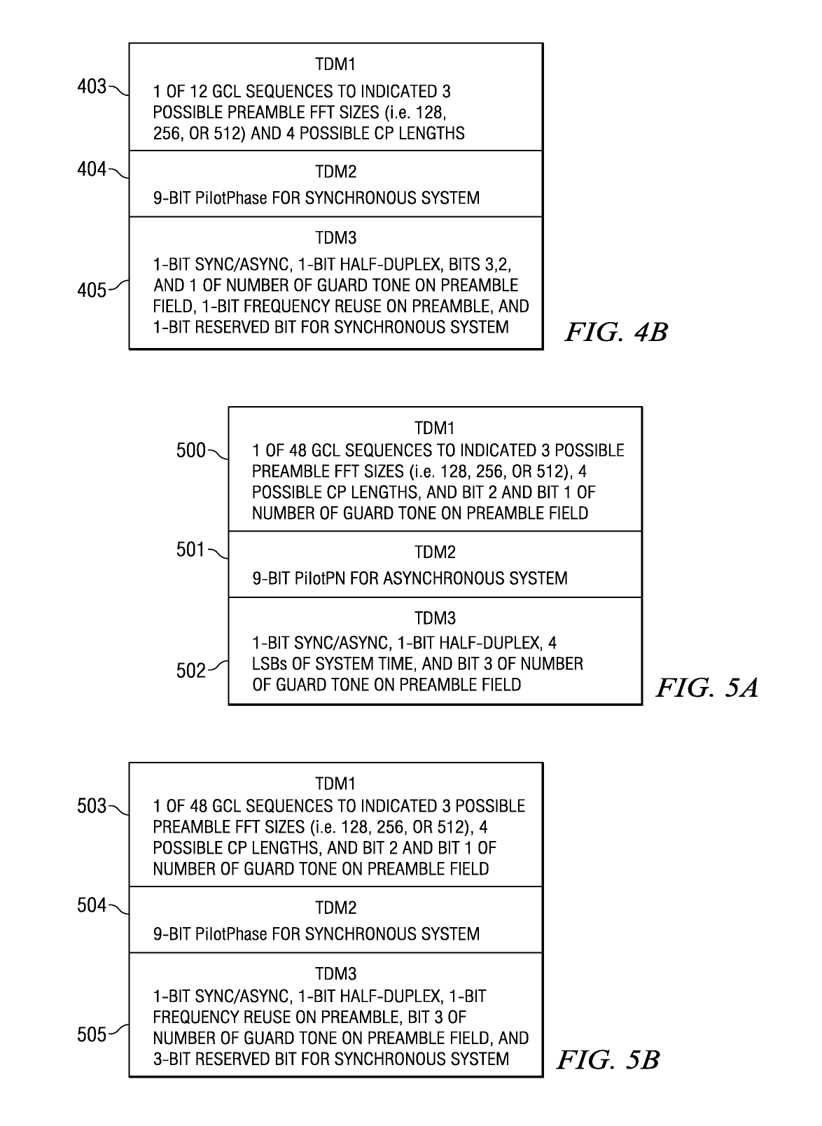

FIG. 4A is a block diagram illustrating acquisition pilots TDM1 400, TDM2 401, and TDM3 402 in a superframe preamble of an asynchronous OFDMA-based network configured according to one embodiment of the present invention. TDM1 400 carries 1 of 12 GCL sequences to indicated 3 possible Preamble FFT sizes (i.e. 128, 256, or 512) and 4 possible CP lengths. For purposes of the described embodiment, the largest FFT size used on the preamble is 512. TDM2 401 in the asynchronous system carries the 9-bit PilotPN.

Considering that the granularity of the traffic resource allocation is 16 sub-carriers, the granularity of guard tone allocation is 32 sub-carriers. Therefore, a 3-bit field (referred to as Bits 3, 2, and 1) of Number of Guard Tones on Preamble can indicate 8 choices of guard tones. For example, the 3-bit field of “000” corresponds to 0 guard tones, “001” corresponds to 32 guard tones, “010” corresponds to 64 guard tones, “011” corresponds to 96 guard tones, “100” corresponds to 128 guard tones, “101” corresponds to 160 guard tones, “110” corresponds to 192 guard tones, and “111” corresponds to 224 guard tones. If more guard tones are still needed, the system will try the 256 FFT size instead of 512.

Acquisition pilot TDM3 402 carries the information regarding the number of guard tones used on the preamble frames. Acquisition pilot TDM3 402 carries a total of 7 bits of information to fit into the smallest FFT size. For a larger FFT size, the time domain waveform is repeated to fit in. Among these 7 bits, a Sync/Async bit is located at a fixed bit position. For example, at the most significant bit (MSB) or Bit 7.

The Sync/Async bit indicates an asynchronous system for purposes of the embodiment illustrated in FIG. 4A. In an asynchronous system, the remaining bits in TDM3 402 are: 1-bit Half-Duplex, 4 LSBs of system time, and the Bit 3 of the Number of Guard Tone on Preamble field. Because this is an asynchronous system, only Bit 3 of the Number of Guard Tone on Preamble field is used in TDM3 402. It will be used as the group index wherein a value of “0” on Bit 3 of the Number of Guard Tone on Preamble field tells the mobile station that the number of guard tones used on the preamble can be any of 0, 32, 64, or 96, and a value of “1” on Bit 3 of the Number of Guard Tone on Preamble field tells the mobile station that the number of guard tones used on the preamble can be any of 128, 160, 192, or 224. Therefore, in the asynchronous system, if the mobile station detects a “0” on the Bit 3 of the Number of Guard Tone on Preamble field in TDM3 402, when demodulating the PBCCH, the mobile station assumes that the worst case scenario of 96 guard tones have been used on the Preamble by the base station. Otherwise, if he mobile station detects a “1” on the Bit 3, when demodulating the PBCCH, the mobile station assumes that the worst case scenario of 224 guard tones have been used on the Preamble by the base station. By providing a limited range of numbers of guard tones to the mobile stations there is less loss of modulation symbols if the base station is, in fact, not using the worst case scenario to send out the PBCCH.

FIG. 4B is a block diagram illustrating acquisition pilots TDM1 403, TDM2 404, and TDM3 405 in a superframe preamble of a synchronous OFDMA-based network configured according to one embodiment of the present invention. As with TDM1 400 (FIG. 4A), TDM1 403 carries 1 of 12 GCL sequences to indicated 3 possible Preamble FFT sizes (i.e. 128, 256, or 512) and 4 possible CP lengths. For purposes of the described embodiment, the largest FFT size used on the preamble is 512. TDM2 404 in the synchronous system carries the 9-bit PilotPhase.

In the synchronous system, the rest of the bits in TDM3 405 are, for example, 1-bit Half-Duplex, Bits 3, 2, and 1 of the Number of Guard Tone on Preamble field, 1-bit to indicate the Frequency Reuse on Preamble, and 1-bit reserved bit. In the synchronous system, the complete field of the Number of Guard Tones on Preamble is indicated in TDM3 405. Therefore, the mobile station, after decoding TDM3 405, can use the exact number of guard tones to demodulate the PBCCH without losing any modulation symbols that the base station sends out.

FIG. 5A is a block diagram illustrating acquisition pilots TDM1 500, TDM2 501, and TDM3 502 in a superframe preamble of an asynchronous OFDMA-based network configured according to one embodiment of the present invention. TDM1 500 carries 1 of 48 GCL sequences to indicated 3 possible Preamble FFT sizes (i.e. 128, 256, or 512), and 4 possible CP lengths. TDM2 501 carries the 9-bit PilotPN. Acquisition pilot TDM1 500 also helps to carry Bit 2 and Bit 1 of the Number of Guard Tone on Preamble field by increasing the numbers of hypotheses on TDM1 500, while TDM3 502 carries Bit 3 of the Number of Guard Tone on Preamble. Thus, after decoding TDM1 500 and TDM3 502, the mobile station can use the exact number of guard tones to demodulate the PBCCH without losing any modulation symbols that the base station sends out for both the synchronous and asynchronous case.

FIG. 5B is a block diagram illustrating acquisition pilots TDM1 503, TDM2 504, and TDM3 505 in a superframe preamble of a synchronous OFDMA-based network configured according to one embodiment of the present invention. TDM1 503 carries 1 of 48 GCL sequences to indicated 3 possible Preamble FFT sizes (i.e. 128, 256, or 512), and 4 possible CP lengths. TDM2 504 carries the 9-bit PilotPhase. Acquisition pilot TDM1 503 also helps to carry Bit 2 and Bit 1 of the Number of Guard Tone on Preamble field by increasing the numbers of hypotheses on TDM1 503, while TDM3 505 carries Bit 3 of the Number of Guard Tone on Preamble. Thus, after decoding TDM1 503 and TDM3 505, the mobile station can use the exact number of guard tones to demodulate the PBCCH without losing any modulation symbols that the base station sends out for both the synchronous and asynchronous case.

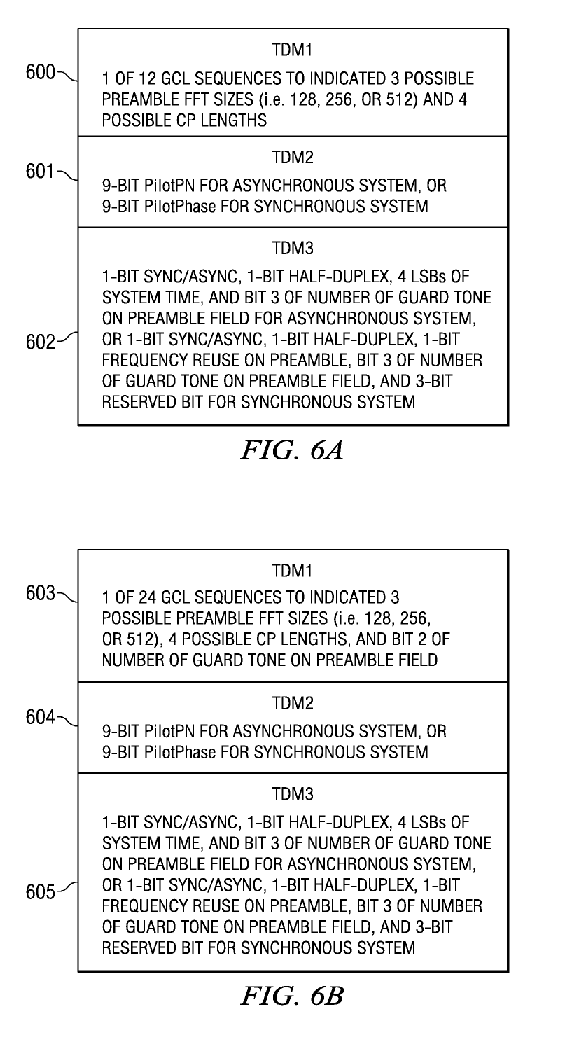

FIG. 6A is a block diagram illustrating acquisition pilots TDM1 600, TDM2 601, and TDM3 602 in a superframe preamble of an OFDMA-based network configured according to one embodiment of the present invention. TDM1 600 carries 1 of 12 GCL sequences to indicated 3 possible Preamble FFT sizes (i.e. 128, 256, or 512) and 4 possible CP lengths. TDM2 601 carries the 9-bit PilotPN for Asynchronous system, or 9-bit PilotPhase for Synchronous system. In the presently-described embodiment, acquisition pilot TDM1 600 does not carry the information related to the number of guard tones, while TDM3 602 carries the Bit 3 of the Number of Guard Tone on Preamble field for both the synchronous and asynchronous cases. Bit 3 will be used as the group index wherein a value of “0” on the Bit 3 of the Number of Guard Tone on Preamble field tells the mobile station that the number of guard tones used on the preamble can be 0, 32, 64, or 96, and a value of “1” on Bit 3 of the Number of Guard Tone on Preamble field tells the mobile station that the number of guard tones used on the preamble can be 128, 160, 192, or 224. Therefore, if the mobile station detects a “0” on the Bit 3 of the Number of Guard Tone on Preamble field in TDM3 602 for either the asynchronous and synchronous system cases, when demodulating the PBCCH, the mobile station assumes that the worst case scenario of 96 guard tones have been used on the Preamble by the base station. Otherwise, if a “1” is detected, when demodulating the PBCCH, the mobile station assumes that the worst case scenario of 224 guard tones have been used on the Preamble by the base station. Dividing the possible numbers of guard tones into definitive sets results in less loss of modulation symbols if the base station is not using the worse case scenario to send out the PBCCH.

FIG. 6B is a block diagram illustrating acquisition pilots TDM1 603, TDM2 604, and TDM3 605 in a superframe preamble of an OFDMA-based network configured according to one embodiment of the present invention. The embodiment of FIG. 6B is configured in the same fashion as the embodiment illustrated in FIG. 6A, with the exception that TDM1 603 also carries Bit 2 of the Number of Guard Tone on Preamble field for both the synchronous and asynchronous case. By providing 2 bits to index the number of guard tone groups the system further narrows down the difference between the worst case scenario and non-worst case scenarios.

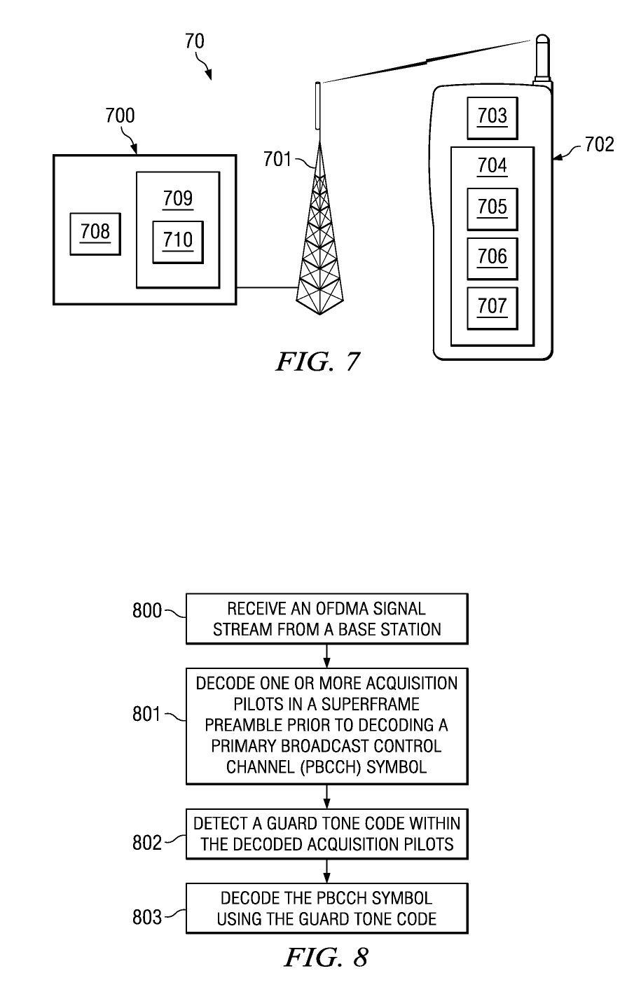

FIG. 7 is a block diagram illustrating OFDMA-based network 70 configured according to one embodiment of the present invention. As mobile station 702 initializes within the sector served by base station 700 and antenna 701, mobile station 702 processes the communication stream from antenna 701. Processor 703 operates decoding scheme 706 saved in memory 704 for decoding the superframe preamble, including the acquisition pilots, TDM1, TDM2, and TDM3. During decoding of the acquisition pilots, mobile station 702 detects a guard tone code, which may be a number of bits, such as 1, 2, 3, or more, located on one or more of the acquisition pilots. Processor 703 operates guard tone component 705 from memory 704 to decode the guard tone code. When decoded, mobile station 702 proceeds to execute another decoding scheme, decoding scheme 707, to decode the PBCCH in the preamble using the decoded information. The guard tone code may represent a specific number of guard tones or a range of possible guard tones for mobile station 702 to use in decoding the PBCCH. By providing mobile station 702 meaningful information to narrow the actual number of guard tones, the acquisition process becomes more efficient and faster.

Base station 700 also includes processor 708 and memory 709. When generating the communication stream, coding component 710, stored in memory 709, is executed by processor 708 to encode the number of guard tones used in coding the preamble superframe into the acquisition pilots. Coding component 710 may either provide a guard tone code that represents the actual number of guard tones used, or one that represents a number of subsets of guard tones that could be used on base station 700.

FIG. 8 is a flowchart illustrating example steps executed to implement one embodiment of the present invention. In step 800, an OFDMA signal stream is received from a base station. One or more acquisition pilots in a superframe preamble are decoded, in step 801, prior to decoding a primary broadcast control channel (PBCCH) symbol. A guard tone code is detected, in step 802, within the decoded acquisition pilots. The PBCCH symbol is decoded, in step 803, using the guard tone code.

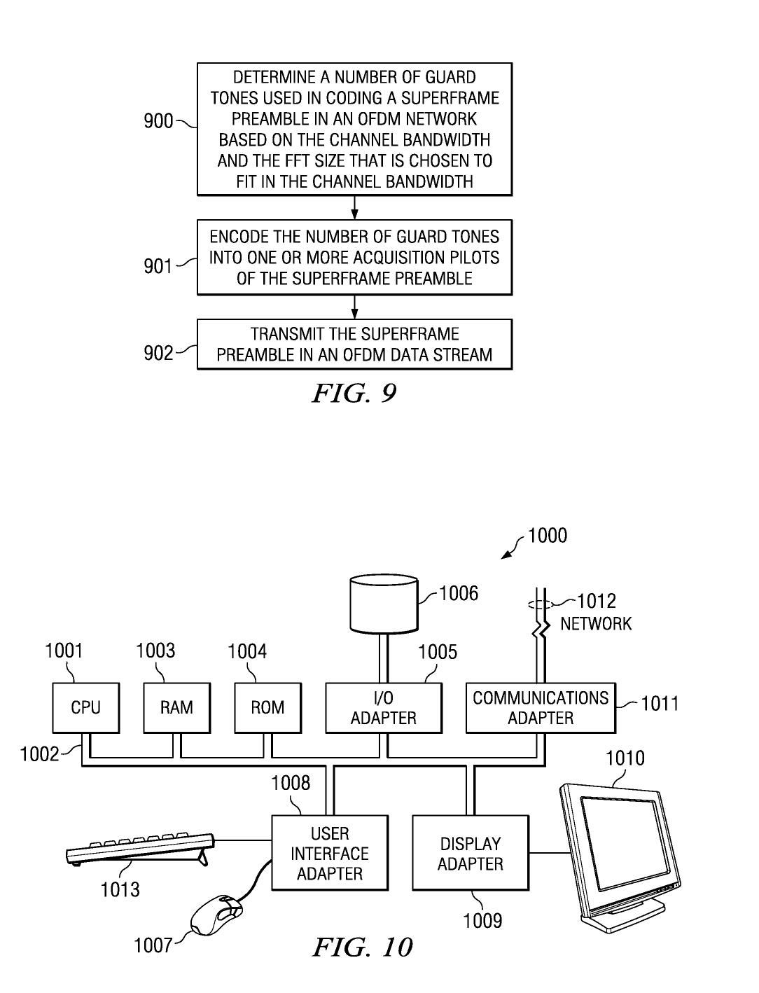

FIG. 9 is a flowchart illustrating example steps executed to implement one embodiment of the present invention. In step 900, a number of guard tones used in coding a superframe preamble in an OFDM network is determined based on the channel bandwidth and the FFT size that is chosen to fit in the channel bandwidth. The number of guard tones is encoded into one or more acquisition pilots of the superframe preamble in step 901. The superframe preamble is transmitted, in step 902, in an OFDM data stream.

The various illustrative logical blocks, modules, and circuits described in connection with the embodiment disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

FIG. 10 illustrates computer system 1000 adapted to use embodiments of the present invention, e.g. storing and/or executing software associated with the embodiments. Central processing unit (CPU) 1001 is coupled to system bus 1002. The CPU 1001 may be any general purpose CPU. However, embodiments of the present invention are not restricted by the architecture of CPU 1001 as long as CPU 1001 supports the inventive operations as described herein. Bus 1002 is coupled to random access memory (RAM) 1003, which may be SRAM, DRAM, or SDRAM. ROM 1004 is also coupled to bus 1002, which may be PROM, EPROM, or EEPROM. RAM 1003 and ROM 1004 hold user and system data and programs as is well known in the art.

Bus 1002 is also coupled to input/output (I/O) controller card 1005, communications adapter card 1011, user interface card 1008, and display card 1009. The I/O adapter card 1005 connects storage devices 1006, such as one or more of a hard drive, a CD drive, a floppy disk drive, a tape drive, to computer system 1000. The I/O adapter 1005 is also connected to a printer (not shown), which would allow the system to print paper copies of information such as documents, photographs, articles, and the like. Note that the printer may be a printer (e.g., dot matrix, laser, and the like), a fax machine, scanner, or a copier machine.

The steps of a method or algorithm described in connection with the embodiments disclosed herein may be implemented or performed directly in hardware, in a software module executed by a processor, or in combination of the two. A software module may reside in RAM memory, flash memory, ROM memory, EPROM memory, EEPROM memory, registers, or any other form of storage medium in the art.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the techniques disclosed in the present invention can be used in a frequency division duplex (FDD) system as well as in a time division duplex (TDD) system or even further varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for acquiring signal in an orthogonal frequency division multiple access (OFDMA)-based network, said method comprising:
receiving an OFDMA signal stream from a base station;
decoding one or more acquisition pilots in a superframe preamble prior to decoding a primary broadcast control channel (PBCCH) symbol;
detecting a guard tone code within said decoded one or more acquisition pilots; and
decoding said PBCCH symbol using said guard tone code.

2. The method of claim 1 wherein said guard tone code comprises one of:
an index identifying a specific subset of a number of guard tones used by said base station; and
an exact number of guard tones used by said base station.

3. The method of claim 1 wherein said OFDMA-based network is one of:
synchronous; or
asynchronous.

4. A method for transmitting a signal in an orthogonal frequency division multiple access (OFDMA)-based network, said method comprising:
determining a number of guard tones used in coding a superframe preamble in said OFDMA-based network based on a channel bandwidth and a fast Fourier transform (FFT) size chosen for said channel bandwidth;
encoding said number of guard tones into one or more acquisition pilots of said superframe preamble; and
transmitting said superframe preamble in an orthogonal frequency division multiplex (OFDM) data stream.

5. The method of claim 4, wherein said encoding comprises:
determining one of a pre-existing plurality of subsets of guard tone numbers that said determined number of guard tones falls into;
assigning a code corresponding to said one of said pre-existing plurality of subsets; and
adding said code into said one or more acquisition pilots.

6. The method of claim 4, wherein said encoding comprises:
assigning a code corresponding to said determined number of guard tones; and
adding said code into said one or more acquisition pilots.

7. The method of claim 4 wherein said OFDMA-based network comprises one of:
a synchronous network; or
an asynchronous network.

8. A mobile station comprising:
a processor;
memory;
an first decoding component stored in said memory, wherein said processor operates said first decoding component to decode one or more acquisition pilots in a superframe preamble of an orthogonal frequency division multiple access (OFDMA)-based network communication stream, wherein said first decoding component directs said mobile station to decode said one or more acquisition pilots prior to decoding a primary broadcast control channel (PBCCH) symbol of said superframe preamble in an OFDMA-based network;
a guard tone code table stored in said memory, wherein said processor accesses said guard tone code table during execution of said first decoding component upon detection of a guard tone code in said decoded one or more acquisition pilots; and
a second decoding component in said memory, wherein said processor operates said second decoding component to decode said PBCCH symbol of said superframe preamble using information in said guard tone code table corresponding to said guard tone code.

9. The mobile station of claim 8, wherein said guard tone code table comprises:
a plurality of subsets, each of said plurality of subsets having a portion of available numbers of guard tones usable by a base station in said OFDMA-based network; and
a one-to-one association of each guard tone code with one of said plurality of subsets.

10. The mobile station of claim 8, wherein said guard tone code table comprises:
a relational database wherein each possible configuration of said guard tone code correlates to an actual number of guard tones used by a base station in said OFDMA-based network.

11. The mobile station of claim 8, wherein said OFDMA-based network comprises one of:
a synchronous network; or
an asynchronous network.

12. A base station in an orthogonal frequency division multiple access (OFDMA)-based network, said base station comprising:
a processor;
memory;
a coding component operable by said processor to encode a number of guard tones used to code a superframe preamble, wherein said encoded number of guard tones is placed into one or more acquisition pilots of said superframe preamble;
a transmitter for transmitting a communication stream including at least said superframe preamble to a plurality of mobile stations.

13. The base station of claim 12, wherein said encoded number of guard tones comprises one of:
identification one of a pre-existing plurality of subsets of guard tone numbers that said number of guard tones falls into; or
identification of said number of guard tones.

14. The method of claim 12 wherein said OFDMA-based network comprises one of:
a synchronous network; or
an asynchronous network

15. A computer program product having a computer readable medium with computer program logic recorded thereon, said computer program product comprising:
code for receiving an orthogonal frequency division multiple access (OFDMA) signal stream from a base station in an OFDMA-based network;
code for decoding one or more acquisition pilots in a superframe preamble prior to decoding a primary broadcast control channel (PBCCH) symbol;
code for detecting a guard tone code within said decoded one or more acquisition pilots; and
code for decoding said PBCCH symbol using said guard tone code.

16. The method of claim 15 further comprising:
code, executable at said base station, for encoding a number of guard tones into said guard tone code, wherein said guard tone code is placed in said one or more acquisition pilots of said superframe preamble; and
code, executable at said base station, for transmitting said superframe preamble in said OFDMA signal stream.

17. The method of claim 15 wherein said guard tone code comprises one of:
an index identifying a specific subset of a number of guard tones used by said base station; and
an exact number of guard tones used by said base station.

18. The method of claim 15 wherein said OFDMA-based network is one of:
synchronous; or
asynchronous.
